(19) United States
(12) Patent Application Publication
(10) Pub. No.: US 2013/0206015 A1
(43) Pub. Date: Aug. 15, 2013

(54) Solid Fuel Grill Temperature Control System

(71) Applicants: Bret David Jacoby, San Jose, CA (US); Michael John Lord, Antelope, CA (US)

(72) Inventors: Bret David Jacoby, San Jose, CA (US); Michael John Lord, Antelope, CA (US)

(21) Appl. No.: 13/571,979

(22) Filed: Aug. 10, 2012

Related U.S. Application Data
(60) Provisional application No. 61/522,835, filed on Aug. 12, 2011.

(51) Int. Cl. A47J 37/07

(52) U.S. Cl. CPC A47J 37/07
USPC 99/330

(57) ABSTRACT

A solid fuel grill containing a controller designed to automatically maintain a user defined cooking temperature. The controller is provided with a temperature signals from a thermocouple probe inside the grill, and calculates the appropriate airflow change needed to increase, decrease or maintain the cooking temperature and drives a motor to position a damper over the air vent to the appropriate position. This allows the grill to automatically maintain an accurate cooking temperature until the food is cooked. A low fuel alarm is initiated when the level of fuel falls below required levels to maintain the desired cooking temperature.

### RELATED APPLICATIONS

This application claims the benefit of U.S. Provisional Application No. 61/522,835, filed Aug. 12, 2011, and which is incorporated herein by reference.

### FIELD OF THE INVENTION

The present invention relates to cooking grills, and more particularly to temperature control of grills that use solid fuel such as, but not limited to, charcoal, wood or pellets.

### BACKGROUND OF THE INVENTION

It can be difficult to control the temperature of a solid fuel grill due to many factors. The primary factor affecting temperature is the amount of air that is allowed to be drawn into the grill which feeds the combustion of the fuel. Air flows into the grill through one or more air intake vents. If a user wants to maintain a constant cooking temperature of a typical solid fuel grill, the user must monitor the temperature of the grill and adjust the air intake vent(s) to compensate for factors that effect cooking temperature, such as the level of fuel remaining, flare ups and external conditions such as wind, rain and ambient temperature. The proper level of air intake vent adjustment is difficult to maintain throughout the entire cooking cycle. Typically, users infrequently adjust the air intake vent, which usually results in large fluctuations in cooking temperature causing inefficient use of fuel, hard to predict cooking times and undercooked or overcooked food. It is especially hard to maintain a consistent cooking temperature when the cooking temperature is low and the cooking time is long. Just one spike in temperature can change the texture of grilled meat thus defeating the purpose of slow cooking Many people resort to gas or electric powered cooking equipment due to the difficulty of maintaining a constant temperature associated with solid fuel grills.

Existing grill temperature controllers use a fan to control the amount of air allowed to enter the grill. Although a fan can be used to control the temperature of a grill, it is preferable to let the natural convection draw the air into the grill. The additional air circulation caused by the fan can dry out the food and cause ash particles to circulate in the cooking environment. The fan style of grill temperature control is also slow to react when lowering the cooking temperature due to the inability to completely seal the grill. Fan style grill temperature controllers also require the user to seal off the existing grill ash removal vents. Due to these requirements, the installation of a fan powered grill temperature controller renders the grills ash removal system useless. The user must uninstall the fan grill controller or manually remove ashes between uses to evacuate the ashes. Therefore, the use of a fan to control air flow into the grill is not ideal.

There is a need for a grill temperature controller that does not rely on a fan.

### BRIEF SUMMARY OF THE INVENTION

The aforementioned issues are addressed by a grill having a grill housing defining a cooking area therein, a grate in the housing positioned at or near the cooking area, a fuel support in the housing for supporting solid fuel, an air vent formed in the grill housing, a damper movably positioned over the air vent wherein a position of the damper relative to the air vent dictates an amount of air flow through the air vent, a motor for adjusting the position of the damper relative to the air vent in response to a drive signal, a controller disposed outside of the grill housing, and a temperature probe disposed in the grill housing at or near the cooking area for measuring a temperature of the cooking area and providing a temperature signal to the controller. The controller is configured to generate and send the drive signal to the motor in response to the temperature signal from the temperature probe.

Other objects and features of the present invention will become apparent by a review of the specification, claims and appended figures.

### BRIEF DESCRIPTION OF THE DRAWINGS

FIG. 1 is a front side view of a kettle grill with an adaptive controller installed in accordance with the invention.

FIG. 2 is a side cross-sectional view of the kettle grill and adaptive controller of FIG. 1 showing the fuel, air intake vents and cooking area.

FIG. 3 is a perspective front view of a smoker style grill with an integrated controller designed in accordance with the invention.

FIG. 4 is a side cross-sectional view of the grill and controller of FIG. 3 showing the fuel and cooking area.

FIG. 5 is a lateral cross-sectional view of a kettle grill shown in FIG. 1 with an adaptive temperature controller attached to the grill's existing damper control rod.

FIG. 6 is a perspective view of the user interface.

FIGS. 7A and 7B illustrate the components of the controller.

FIG. 8 is a side cross-sectional view of the grill illustrating direct cooking

FIG. 9 is a side cross-sectional view of the grill illustrating indirect cooking

FIG. 10 is a top cross sectional view of the grill illustrating the fuel bin in its closed position.

FIG. 11 is a top cross sectional view of the grill illustrating the fuel bin in its open position.

### DETAILED DESCRIPTION OF THE INVENTION

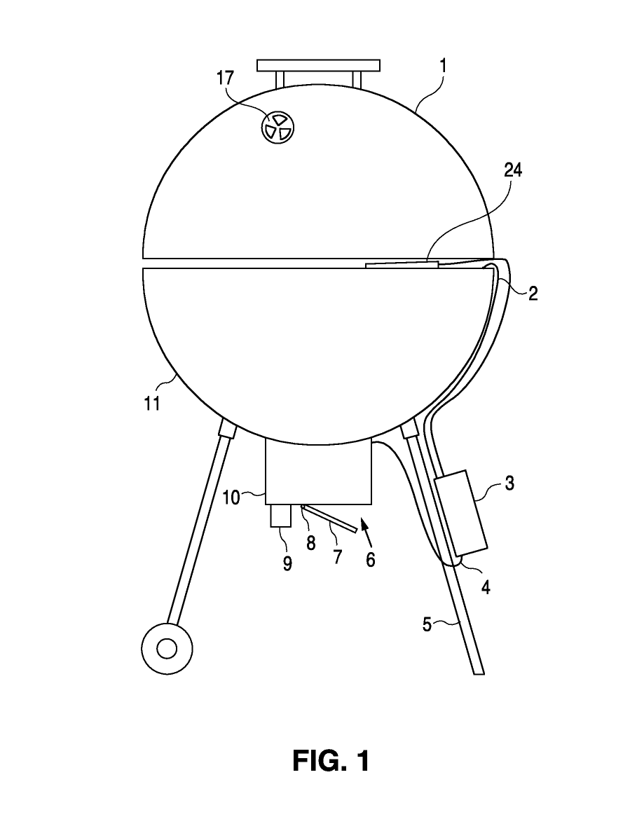

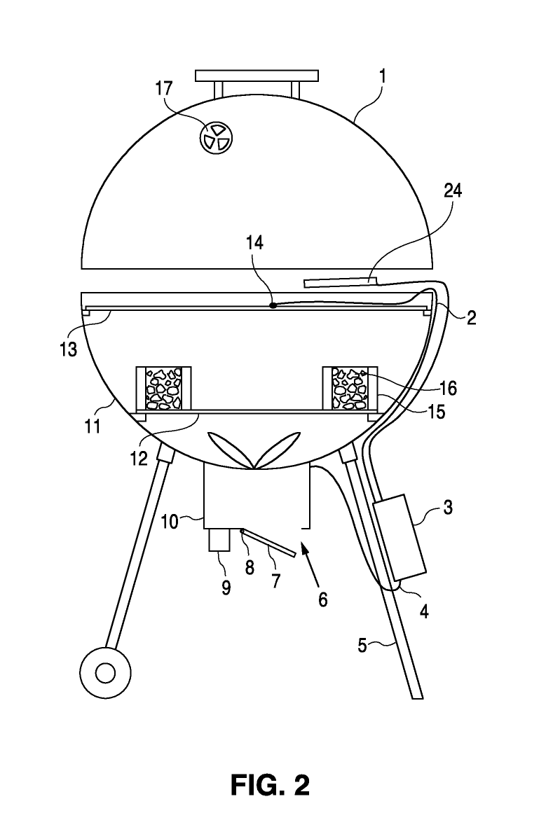

The present invention is a temperature controller system for solid fuel grills. As illustrated in FIGS. 1 and 2, a kettle style grill is a rounded housing 11 with an open upper end, and includes a fuel grate 12 on which solid fuel 16 is placed, and a cooking grate 13 on which the food is placed. Fuel baskets 16 can be used to contain the fuel 15 on fuel grate 12. The grill 11 is supported by support legs 5. A lid 1 can be placed on the grill housing 11 to seal the cooking area. The lid 1 can include an adjustable air vent 17. Grill 11 includes a vent housing 10 that defines an air vent 6 below the fuel grate 12, with an adjustable damper 7 rotatable about a hinge 8 that adjustably covers vent 6 thus dictating the amount of air that will be drawn into the grill 11 through vent 6.

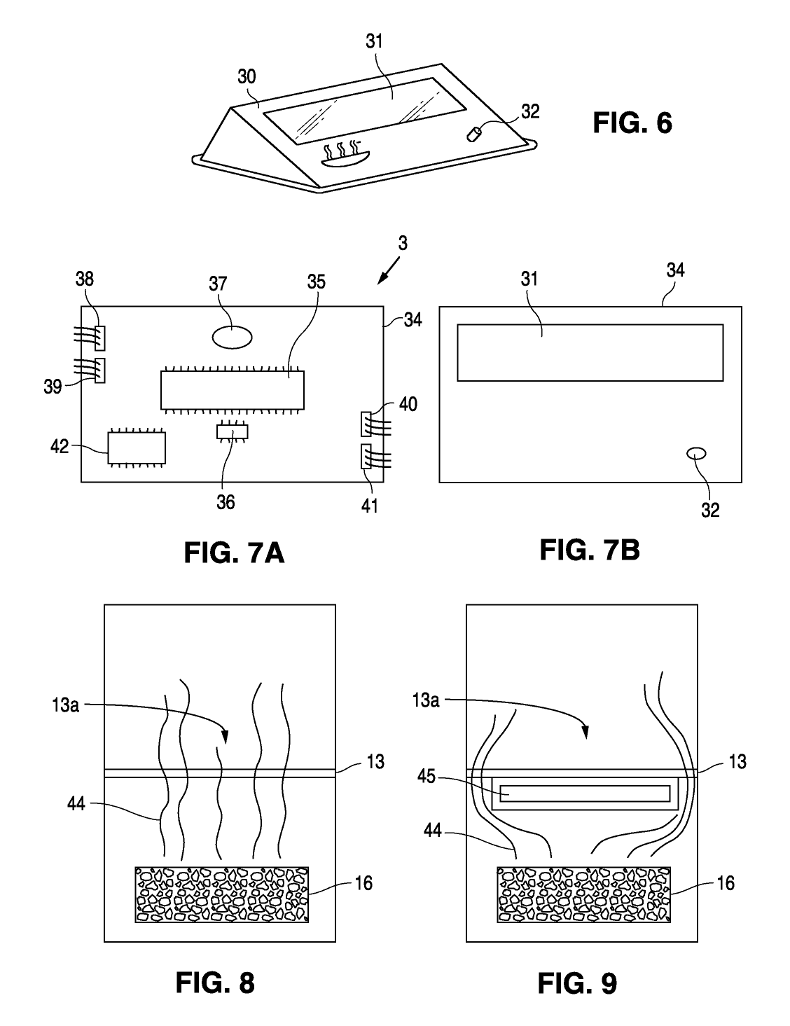

Grill 11 includes a temperature controller 3 preferably but not necessarily mounted to one of the legs 5. A thermocouple wire 2 connected to the controller 3 extends into the grill and terminates with a thermocouple probe 14 for measuring the temperature at or near the cooking grate 13 (e.g. at the cooking area just above cooking grate 13). The controller 3 is connected to a motor 9 via cable 4, where motor 9 rotates control damper 7 about hinge 8 to adjust how much damper 7 blocks air from flowing into vent 6. Controller 3 can be programmed with a target temperature, and automatically operates motor 9 to move control damper 7 to adjust the amount of air flowing through vent 6 and into the grill to achieve the target temperature as measured by probe 14. By adjusting the amount of air flowing into the grill, the controller 3 is able to accurately regulate the cooking temperature at or near the cooking grate 13. The controller 3 can include a knob, switch or other user operative mechanism for the user to program controller 3 with the desired target temperature, and a visual display (see discussion below with respect to FIGS. 6 and 7). A food temperature probe 24 can be connected to controller 3 and inserted into the food being cooked for measuring the food temperature. Additionally or alternately, controller 3 can adjust air flow into the grill using damper 7 based upon measured food temperature.

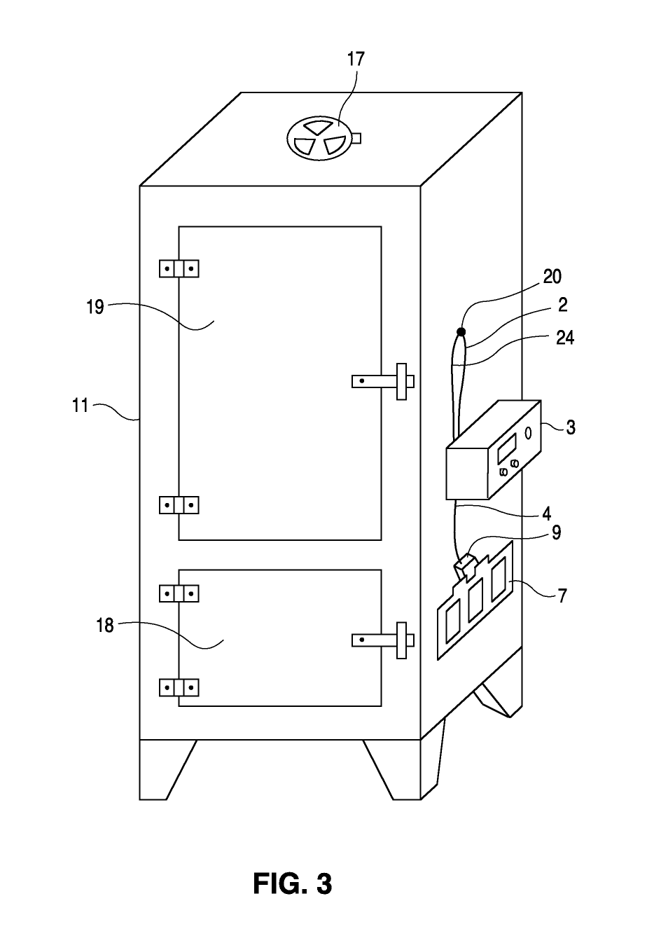

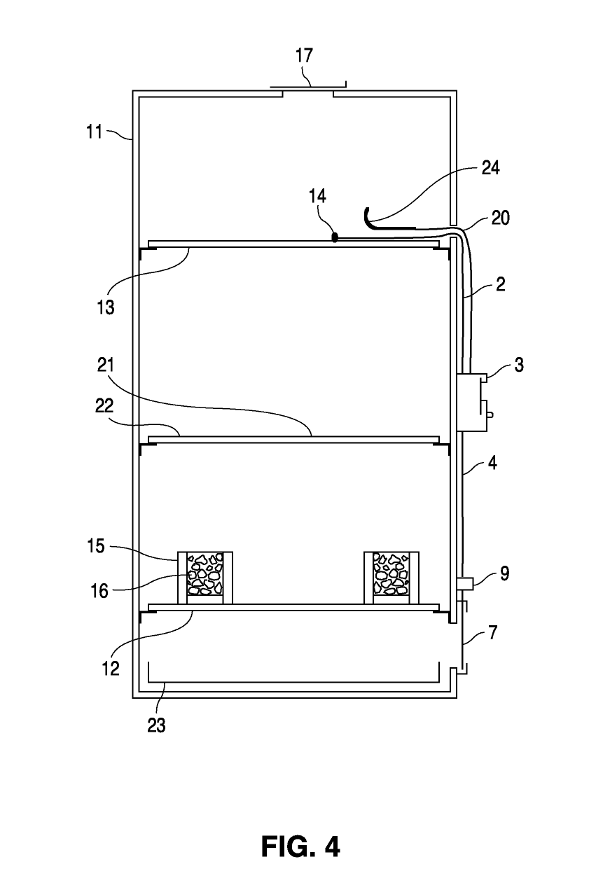

FIGS. 3-4 illustrate a smoker style grill 11 with similar components as the kettle style grill of FIGS. 1-2 (like components are illustrated with the same element numbers). The smoker style grill includes the controller 3 that uses thermocouple probe 14 to monitor the internal temperature of the grill at or near the cooking grate, and/or food temperature probe 24, and in response to measured temperature(s) drives motor 9 to operate damper 7 to regulate the airflow into the grill. The smoker style grill further includes pass-through hole 20 through which probe 24 extends, ash tray 23 to capture ashes from the spend solid fuel 16, and a lower cooking grate 22 for cooking food closer to the fuel 16. Grate 22 provides an alternative probe location 21 for probes 14 and/or 24.

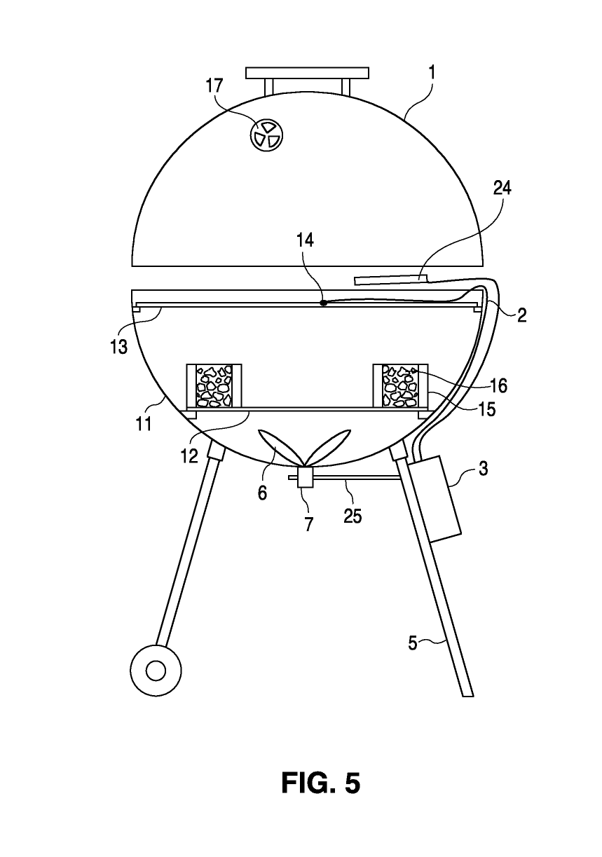

FIG. 5 illustrates an alternate embodiment of the grill of FIGS. 1-2, where vent 6 is formed in the grill's housing 11, and damper 7 is operated by a control rod 25 which is rotated by motor 9 inside controller 3 to selectively open or close vent 6.

Controller 3 monitors the cooking temperature and automatically adjusts the amount of air allowed to enter the grill. By adjusting the amount of air allowed to reach the fuel, the controller can increase or decrease the burn rate of the fuel thus adjusting the cooking temperature. Controller 3 may take the form of an adaptive system that attaches to an existing grill or as an integrated system on a new grill. The temperature of any size or shape solid fuel grill can be controlled using this system. Advantages of the invention include providing an improved solid fuel grill that maintains a constant cooking temperature thus reducing the amount of fuel consumed, that allows the cooking of items that require strict temperature control, requires less interaction from the user, that produces predictable cooking times and that provides a means for accurately slow cooking over a long period of time.

To operate the grill, fuel 16 is placed in the fuel baskets 15 (fuel baskets 15 can be a single fuel bin). The user then ignites the fuel using a built-in gas fuel assisted starting device or by alternative means. Once the grill has reached cooking temperature, the food probe 24 (if used) is placed in the food, the food is placed on the cooking grate 13 or 22 and the grill is sealed. The user then sets the desired cooking temperature on the controller 3. There are multiple methods for programming the controller. In the simplest mode the user can just set the desired temperature. The user also has the option to enter the type and weight of the food, and the desired completion time. In this mode the controller 3 will automatically regulate the cooking temperature to achieve the desired food cooking or temperature in the allotted time. In another mode, the user can input the food type, the food weight and the desired food temperature or cook temperature. The controller will let the user know how long it will take to either achieve the desired food temperature using the selected method or how long it will take to cook the food at the desired cook temperature (of the cooking area). After the controller has been programmed it automatically takes the following actions:
(1) monitors and displays the current cooking temperature as measured by probe 14;
(2) monitors and displays the current food temperature if food probe 24 is used;
(3) displays the current desired cooking temperature;
(4) displays the amount of time left before the food reaches the desired temperature;
(5) adjusts the damper 7 to increase or decrease airflow as needed to regulate the cooking temperature of the grill, which is done in accordance with the cooking information entered by the user;
(6) provides a low fuel alarm when the amount of fuel is inadequate to maintain the desired temperature (i.e. maximum airflow is provided yet the fuel is insufficient to achieve the desired temperature); and
(7) notifies the user when cooking is complete or when user intervention is needed.

The grill 11 can include one or more of the following features and/or components:
(a) The controller 3 includes a user interface that allows the user to 1) set the desired cooking temperature 2) set the desired food temperature 3) set a timer and 4) be warned visually and/or audibly when additional fuel is needed. FIG. 6 illustrates the user interface 30, which includes a display 31 (e.g. LCD) and a rotary knob 32. The rotary knob 32 can be turned by the user to change a value, and pressed to make a selection. The controller 3 contains an electronic circuit that can read the temperature of the food as well as the internal grill temperature (also referred to as the cooking temperature) and adjust the damper 7 preferably based on a set of proportional, integral and differential (PID) parameters to achieve the desired internal temperature or desired cooking time.
(b) A preferred configuration of controller 3 is illustrated in FIGS. 7A-7B, and includes a printed circuit board (PCB) 34 on which are mounted a microprocessor 35, memory chip 36, sound device 37 (e.g. speaker), incoming power connector 38, servo motor connector 39 (for sending a drive signal to motor 9), thermocouple input 40 (for receiving a temperature signal from probe 14), thermister input 41 (for receiving a temperature signal from probe 24), two way wireless communication device 42 (for communicating to the user remotely using a portable electronic device), rotary knob 32 and the display 31.

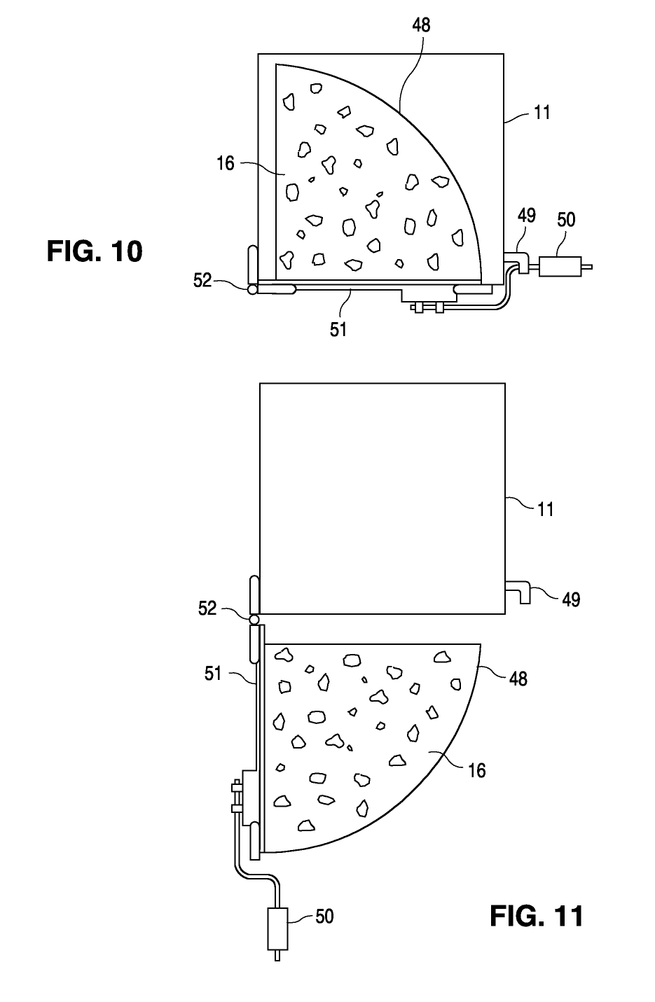

Microprocessor 35 can be any conventional computing device, which is configurable or configured through firmware and/or software to monitor temperature, control the user interface, store and retrieve information in a memory chip 36, calculate cooking times, and drive the motor 9. The microprocessor 35 can be used to monitor both food and grill temperatures, calculate the appropriate amount of air to let into the grill, drive the motor 9 to adjust the damper 7, monitor the user interface inputs and control the user interface display 31.
(c) As a non-limiting example, a Maxim MAX6675 chip can be used to read the probe 14 and perform a cold junction compensation. This chip reads the voltage created by the two dissimilar metals in the probe 14 and converts that voltage into a temperature reading. This temperature is then communicated to the microprocessor 35.
(d) The microprocessor 35 is configured with software and/or firmware to calculate the required position of damper 7 to maintain or achieve the appropriate internal temperature of the grill given the heat being generated by the fuel 16. The microprocessor 35 calculates an “error” value as the difference between measured temperature and desired temperature. The microprocessor 35 minimizes the error by continually adjusting the damper 7 to allow the appropriate amount of air to reach the fuel.
(e) Memory chip 36 can be integral to microprocessor 35 or separate as shown, and is used to store and retrieve information. This memory chip 36 may be used to store historic temperature data, alternate PID parameters and cooking time information for different foods.
(f) The microprocessor 35 can calculate the cooking temperature needed to cook a specific food in a user defined time period. This will allow the user to enter into the controller 3 the food type and weight as well as the time that he/she would like the food to be fully cooked, and optionally a desired internal temperature. The microprocessor will adjust the cooking temperature to have food ready at the desired time. The controller can monitor the internal temperature of the food and adjust the heat to meet the calculated cooking time.
(g) The wireless communication device 42 can be a transmitter or transceiver (e.g. Bluetooth, WiFi, Radio Frequency module, etc.) for remote monitoring and control of the grill. Status commands such as but not limited to any user interface function, “low fuel”, “food is ready”, “overheat”, “under heat”, “estimated completion time” and “current temperature” may be sent to the user via either of these protocols. A user dedicated receiver or transceiver can be used to receive the status commands and either display them and/or provide an audible signal. The user receiver/transceiver could instead be any mobile or fixed device configured to receive and display such commands, such as mobile phone, PDA, computer, tablet, etc. The user may read current grill data such as grill temperature, food temperature, etc., and send commands back to the controller 3 to, for example, adjust any controller setting.
(h) An optional baffle system can be included inside the grill to allow indirect heat cooking Specifically, FIG. 8 illustrates direct heat cooking, where heat 44 from the fuel 16 rises up directly to the cooking area 13a on the cooking grate 13. FIG. 9 illustrates a baffle system 45 disposed between the fuel 16 and cooking grate 13, which partially or completely blocks heat 44 (forcing heat around the edges and/or through openings in the baffle system 45). Baffle system 45 can be one or more plates that are either fixed or adjustable in position and/or have adjustable openings such that baffle system 45 deflects (i.e. redirects) heat 44 to provide a desired distribution of heat at the cooking area 13a that is different from the heat distribution created just by fuel 16. The use of removable or adjustable baffles allows the same grill to be used for both direct and indirect cooking methods, and can be used to eliminate hot spots for more even cooking
(i) An optional fuel bin 48 can be included in the grill which replaces fuel grate 12 and fuel baskets 15. Fuel bin 48 which rotates between a cooking position inside the grill (as illustrated in FIG. 10) and a reloading position outside of the grill (as illustrated in FIG. 11) for easy loading of fuel. Bin 48 supports the fuel 16 during cooking, and includes a fuel bin door latch 49, fuel bin door handle 50, fuel bin door 51, and fuel bin door hinge 52. When fuel needs to be added, the user can unlatch and pull out the bin 48, unload spent fuel if necessary, and load bin 48 with fuel 16 without any obstructions limiting access, and rotate the bin closed to position the fuel 16 in the cooking position. This also keeps the ashes that are released during the reloading of the fuel from coming in contact with the food.

It is to be understood that the present invention is not limited to the embodiment(s) described above and illustrated herein, but encompasses any and all variations falling within the scope of the appended claims. For example, references to the present invention herein are not intended to limit the scope of any claim or claim term, but instead merely make reference to one or more features that may be covered by one or more of the claims. Hardware, software and/or firmware can be used to implement the logic steps and/or processes of the invention. It should further be appreciated that such logic steps or process can be implemented as computer-executable instructions stored on a non-transitory computer readable medium, such a CD or DVD (including re-writable CDs and DVDs), flash or other non-volatile memory, ROM, EEPROM, disc drive, solid state drive, etc.

What is claimed is:

1. A grill comprising:
a grill housing defining a cooking area therein;
a grate in the housing positioned at or near the cooking area;
a fuel support in the housing for supporting solid fuel;
an air vent formed in the grill housing;
a damper movably positioned over the air vent, wherein a position of the damper relative to the air vent dictates an amount of air flow through the air vent;
a motor for adjusting the position of the damper relative to the air vent in response to a drive signal;
a controller disposed outside of the grill housing;
a temperature probe disposed in the grill housing at or near the cooking area for measuring a temperature of the cooking area and providing a temperature signal to the controller;
wherein the controller is configured to generate and send the drive signal to the motor in response to the temperature signal from the temperature probe.

2. The device of claim 1, wherein the controller includes a user interface for receiving user input.

3. The device of claim 2, wherein the controller is configured to adjust the drive signal in response to received user input.

4. The device of claim 3, wherein the user input is a target cook temperature, and the controller is configured compare the target cook temperature and the temperature signal, and wherein the generation of the drive signal is based on the comparison.

5. The device of claim 2, wherein the user interface includes a display for displaying status messages.

6. The device of claim 2, wherein the user interface includes a sound generating device for generating audible sounds.

7. The device of claim 2, further comprising:
a second temperature probe configured for insertion into food for measuring a temperature thereof, and configured to provide a second temperature signal to the controller;
wherein the controller is further configured to generate and send the drive signal to the motor in response to the second temperature signal from the second temperature probe.

8. The device of claim 2, wherein the controller comprises a microcontroller that is configured to receive a food type, a food weight, and a cook time from the user interface, and is further configured to generate and send the drive signal to the motor in response to the received food type, the food weight and the cook time.

9. The device of claim 2, wherein the controller comprises a microcontroller that is configured to:
receive a food type, a food weight, and a cook time from the user interface;
calculate a target cook temperature based upon the received food type, the food weight and the cook time;
generate and send the drive signal to the motor to maintain a temperature at the cooking area at or near the target cook temperature.

10. The device of claim 9, wherein the microcontroller is further configured to display the calculated target cook temperature on a visual display of the user interface.

11. The device of claim 2, wherein the controller comprises a microcontroller that is configured to receive a food type, a food weight, and a target cook temperature from the user interface, and is further configured to generate and send the drive signal to the motor in response to the received food type, the food weight and the target cook temperature.

12. The device of claim 2, wherein the controller comprises a microcontroller that is configured to:
receive a food type, a food weight, and a target cook temperature from the user interface;
calculate a cook time based on the received food type, the food weight and the target cook temperature;
generate and send the drive signal to the motor to achieve the target cook temperature at the cook area.

13. The device of claim 12, wherein the microcontroller is further configured to display the calculated cook time on a visual display of the user interface.

14. The device of claim 1, wherein the fuel support is a grate.

15. The device of claim 1, wherein the fuel support is a bin that is rotatably connected to the housing for rotating between an open position outside of the housing and a closed position inside the housing.

16. A grill comprising:
a grill housing defining a cooking area therein;
a grate in the housing positioned at or near the cooking area;
a fuel support in the housing for supporting solid fuel;
an air vent formed in the grill housing;
a damper movably positioned over the air vent, wherein a position of the damper relative to the air vent dictates an amount of air flow through the air vent;
a motor for adjusting the position of the damper relative to the air vent in response to a drive signal;
a controller disposed outside of the grill housing;
a temperature probe configured for insertion into food disposed in the grill housing for measuring a temperature thereof, and configured to provide a temperature signal to the controller
wherein the controller is configured to generate and send the drive signal to the motor in response to the temperature signal from the temperature probe.

17. The device of claim 16, wherein the controller comprises a microcontroller that is configured to receive a food type, a food weight, and a target food temperature from the user interface, and is further configured to generate and send the drive signal to the motor in response to the received food type, the food weight and the target food temperature.

18. The device of claim 16, wherein the controller comprises a microcontroller that is configured to:
receive a food type, a food weight, and a target food temperature from the user interface;
calculate a cook time based on the received food type, the food weight and the target food temperature;
generate and send the drive signal to the motor to achieve the target food temperature.

19. The device of claim 18, wherein the microcontroller is further configured to display the calculated cook time on a visual display of the user interface.
